(19) United States
(12) Patent Application Publication
(10) Pub. No.: US 2016/0217326 A1
(43) Pub. Date: Jul. 28, 2016

(54) FALL DETECTION DEVICE, FALL DETECTION METHOD, FALL DETECTION CAMERA AND COMPUTER PROGRAM

(71) Applicant: NEC Corporation, Minato-ku, Tokyo (JP)

(72) Inventor: Toshinori HOSOI, Tokyo (JP)

(21) Appl. No.: 14/414,266

(22) PCT Filed: Jul. 3, 2013
(86) PCT No.: PCT/JP2013/041119

§ 371 Date: Jan. 12, 2015

(51) Int. Cl. G06K 9/00; G06T 7/00; G06K 9/46

(52) U.S. Cl. CPC G06K 9/00369; G06K 9/4609; G06T 7/0044; G06T 2207/30196

(57) ABSTRACT

Disclosed is a fall detection device and the like such that even when a video with low frame rate is used, and a CPU that demonstrates inferior performance is employed, it is possible to detect, with a higher accuracy, that a human body has fallen.

This fall detection device 1 comprises includes a height detection unit 2 detects whether or not the height of a human body decreases, an appearance feature extraction unit 3 that extracts an appearance feature, an appearance detection unit 5 that determines whether or not the human body has fallen and a moving distance detection unit 4 that detects when the moving distance is small, that the human body to be detected has fallen.

### TECHNICAL FIELD

The present invention to a technical field for detecting, by using image processing, etc., that the person or the like has fallen down to the ground.

### BACKGROUND ART

As a commonly known technology for detecting that the person (human body) or the like has fallen, there exist, for example, a device and a system including sensors or the like such as acceleration sensors or gyro-sensors, which are attached to the human body, thus to analyze information output from those attached sensors to thereby estimate the behavior of the human body.

By using such a technology, for example, a device administrator can relatively easily discover that the human body has been fallen. On one hand, the device administrator is required to attach sensors onto the human body to be detected, or to make the body possess such sensors. For this reason, technologies commonly known have limited scenes (situations) available.

More specifically, for example, in the case where unspecified persons have fallen down onto the ground in public places, such unspecified persons are required to have sensors so far as commonly known technologies go. For this reason, realization thereof is impossible.

As a technology for detecting that the person has fallen as described above, there exist a device and a system adapted not only to detect fall of the human body by means of sensors or the like, but also to detect, on the basis of images taken by using a camera, etc., the event that the human body has fallen.

As a related art existing prior to the present application, for example, Patent document 1 discloses a fall detection device adapted for automatically detecting that the person has fallen.

More specifically, the fall detection device disclosed in Patent document 1 extracts a difference region between an image taken by a camera and an image obtained when no human body exists. This fall detection device detects the falling action of the human body the basis of an area of the extracted difference region.

In Patent document 1, it is unnecessary to attach special sensors or the like onto a human body to be detected, or to make it possess such sensors. In Patent document 1, it is possible to grasp the human body existing within a range which can be imaged by a camera.

On the other hand, the area of the difference region described in Patent document 1 strongly depends upon the condition required at the time of imaging the human body to be detected. More specifically, the area of the difference region is strongly affected by installation angle of camera. For this reason, in Patent document 1, at the time of calculating such the area, it is necessary to make adjustment in dependence upon the installation angle of the camera.

When reference is now made to the technology described in Patent document 2, there is disclosed a technology for detecting, from a temporal change in an image region indicating a person included within an image, a change in the attitude of the person.

More specifically, a posture-change detection device includes the following components:

person detection means adapted to detect the person from an image which has been acquired by means of imaging means;

height estimation means adapted to estimate the height of the detected person; and

means adapted to compare a ratio of changes in the vertical size and the lateral size of the person on the image obtained by the height estimation means and an attitude pattern which has been set in advance to thereby recognize the attitude of the person.

The posture-change detection device in Patent document 2 compares ratio between “stature (height)” and “width” of the person on the image and posture patterns corresponding to respective postures to thereby detect a specific posture.

Thus, the posture-change detection device determines a posture on the basis of information between “stature (height)” and “width” estimated from the image region indicating the person included within the image. For this reason, the posture-change detection device can detect a posture with a lesser amount of calculation (low processing capability).

When reference is made to the technology disclosed in Patent document 3, there is disclosed a technology for detecting occurrence of the behavior indicating, for example, fall of an observed object.

More specifically, the posture-detection device extracts, on the basis of acquired left and right images, information indicating a human region indicating a person existing within a three-dimensional space (hereinafter referred to as “three-dimensional human region information”). Next, the posture-detection device calculates height, width and depth information of the three-dimensional human region from the extracted three-dimensional human region information. Further, the posture-detection device determines posture of an observed object based on ratios of the width to the height and of the depth to the height of the three-dimensional human region from the calculated information.

Moreover, the posture-detection device is required for counting, in advance, a camera, a lens and a camera installation environment (hereinafter referred to as “parameters of camera”) in order to calculate sizes (the height, width and depth of the human region within the three-dimensional space) from the three-dimensional human region information. For this reason, the processing itself for calculating the sizes on the basis of three-dimensional human region information in Patent document 3 can be executed with a lesser amount of calculation (low processing capability).

Thus, in Patent document 3, an acquired image is converted into a size corresponding to the human region on the three-dimensional space. In Patent document 3, processing the converted size can, thus suppress the influence, for example, of the installation angle of the camera.

On one hand, it is generally known that the size on the three-dimensional space has a large error in the optical axis (depth) direction of the camera lens.

When reference is now made to the technology described in Patent document 4, there is disclosed such a technology to detect the fall of aged persons.

More specifically, a detection device disclosed in Patent document 4 takes an image of an observed object by a camera. The detection device detects a motion vector of the observed object on the basis of the photographed image. Further, the detection device compares the detected motion vector and fall vectors of the observed object stored in advance to thereby determine whether or not the observed object has fallen.

The detection device captures the behavior at the moment of falling the observed object thereby determine whether or not the observed object has fallen. For this reason, the detection device is required to have a video with a frame rate high enough to determine the behavior of the observed object.

In the technology described in Patent document 5, data of a partial region of a human body or a specific region is extracted on the basis of image data which has been captured by means of a fixed camera. Further, Patent document 5 discloses the technology relating to a human behavior understanding system of grasping behavioral features of a person from the respective extracted data to thereby understand the behavior of the person.

More specifically, the human behavior understanding system includes the following components:

an imaging unit for performing detection of an imaging region including a person as an object;

a behavioral feature detection unit for detecting features of a behavior by a change amount of partial region data, and

a behavior understanding unit for combining the detected features of behaviors to thereby determine the behavior of the person.

For this reason, the human behavior understanding system in Patent document 5 determines the behavior of a person from detected behavior features based on a plurality of partial region data. For this reason, the human behavior understanding system requires complicated arithmetic processing.

### CITATION LIST

### Patent Literature

[PTL 1] Japanese Patent Publication No. 2000-207664

[PTL 2] Japanese Patent Publication No. 2010-237873

[PTL 3] Japanese Patent Publication No. 2008-146583

[PTL 4] Japanese Patent Publication No. 2002-232870

[PTL 5] Japanese Patent Publication No. 2005-258830

### SUMMARY OF INVENTION

### Technical Problem

However, the technologies described in above-described Patent documents 1 to 3 detect, on the basis of information indicating “area”, “stature (height)”, “width” and “depth”, etc. which are not so highly directly related to fall of the person, whether or not the person has fallen.

Accordingly, the technologies lack information necessary for precisely determining the event of the state of the person (“fallen state” or “non-fallen state”). For this reason, the technologies have a poor accuracy for detecting fall (detection accuracy). Accordingly, with these technologies, it is impossible to detect the fall of the person.

More precisely, for example, in Patent document 1, in the case where a camera installed on ceiling images a falling action of the person directly below, if imaging environments such as imaging position of the person, overlapping thereof, shadow or illumination change, etc. are not very special and ideal, it is impossible to detect the falling action of the person on the basis of “area”.

Further, in Patent document 2, attitude of the person is detected on the basis of “stature (height)” and “width”. For example, in Patent document 2, “stature (height)” is low and “width” is broaden both in the attitude in which the person sits on, for example, the ground (floor) with his legs being stretched and in the attitude in which the person has fallen. For this reason, in the case of Patent document 2, it is difficult to distinguish or determine between the case where the legs of the person are stretched and the case where he has fallen.

Sizes of a human region within the three-dimensional space (height, width and depth within the three-dimensional space) in Patent document 3 are obtained by determining positions of a pair of corresponding feature points from left and right images. For this reason, any error may take place in those sizes in the case where there exist a plurality of similar feature points in the images. As a result, in Patent document 3, it is difficult to detect occurrence of, for example, fall of an observed object. Thus, in the case of Patent document 3, the fact that the detection accuracy in fall is low becomes problem.

The system of detecting fall by using the motion vector of an observed object on the basis of the photographed image in Patent document 4 detects fall of the observed object by capturing the behavior at the moment in the act of falling. For this reason, in the case of a video with low frame rate such as the photographed image mentioned above, it is difficult to capture a necessary behavior.

Further, in Patent document 4, in the case of detecting fall on the basis of the photographed images, overlooking the moment in the act of falling of the observed object takes place. For this reason, in the case of Patent document 4, it is difficult to detect fallen state.

More specifically, for example, in Patent document 4, it is difficult to detect the motion vector from images captured by using a camera having a low frame rate, such as a network camera connected to Internet.

In Patent document 5, behavior of the person is detected on the basis of a plurality of partial region data set representing a human body which are extracted subject images. A processing for detecting the behavior of the person, it is necessary to process the plurality of partial region data set representing the human body. Further, the processing, it is necessary to combine a plurality of detected features of action.

For this reason, the human behavior understanding system may not only need a complicated processing, but also result in high calculation cost. In this human behavior understanding system, high performance Central Processing Unit (hereinafter referred to as “CPU”) may be required.

Further, in the case of the above-described commonly known technology, it is impossible to solve, at the same time, problems of “detection accuracy of fall is low”, “high video frame rate is required for the purpose of detecting fall”, and “high performance CPU is required because the processing is complicated”, etc.

A principal object of the present invention is to provide a fall detection device and the like such that even when a video with low frame rate is used, and a CPU that demonstrates inferior performance is employed, it is possible to detect, with a higher accuracy, that a human body has fallen.

### Solution to Problem

To overcome the above-described problems, a fall detection device according to the present invention includes the following components.

That is, the fall detection device includes:

a height detection unit that detects whether or not a height of a human body to be detected decreases, by comparing, on the basis of a human body image including a partial image indicating the human body, position coordinate information indicating a position on coordinate of the partial image and size information indicating the size of the human body indicated on the partial image, height information included in the size information and height information included in size information acquired in the past;

an appearance feature extraction unit that extracts, when the height decreases, an appearance feature on the basis of appearance of the human body image;

an appearance detection unit that determines, on the basis of a result obtained by making reference to a first appearance dictionary on the basis of the appearance feature, whether or not the human body has fallen; and

a moving distance detection unit that calculates, when it is determined that there results fallen state, a moving distance of the partial image included in the human body image on the basis of the position coordinate information and position coordinate information acquired in the past, compares the moving distance and a threshold value, to detect, on the basis of the compared result, whether or not the moving distance of the partial image indicating the human body is smaller than the threshold value, when the moving distance is small, and detects that the human body included in the human body image has fallen.

Moreover, in order to attain the same object, a fall detection method has the following components.

That is, the fall detection method includes:

detecting whether or not a height of a human body to be detected decreases, by comparing, on the basis of a human body image including a partial image indicating the human body, position coordinate information indicating a position on coordinate of the partial image and size information indicating the size of the human body indicated on the partial image, height information included in the size information and height information included in the size information acquired in the past;

extracting an appearance feature on the basis of appearance of the human body image when the height decreases;

determining, on the basis of a result obtained by making reference to a first appearance dictionary on the basis of the appearance feature, whether or not the human body has fallen; and

calculating a moving distance of the partial image included in the human body image on the basis of the position coordinate information and position coordinate information acquired in the past when it is determined that there results fallen state, compare the moving distance and a threshold value, to detect, on the basis of the compared result, whether or not the moving distance of the partial image indicating the human body is smaller than the threshold value, when the moving distance is small, and detects that the human body included in the human body image has fallen.

Further, in order to attain the same object, a fall detection camera according to the present invention has the following components.

That is, the fall detection camera includes:

a height detection unit that detects whether or not a height of a human body to be detected decreases, by comparing, on the basis of a human body including a partial image indicating the human body, position coordinate information indicating a position on coordinate of the partial image and size information indicating the size of the human body indicated on the partial image, height information included in the size information and height information included in size information acquired in the past;

an appearance feature extraction unit that extracts, when the height decreases, an appearance feature on the basis of appearance of the human body image;

an appearance detection unit that determines, on the basis of a result obtained by making reference to a first appearance dictionary on the basis of the appearance feature, whether or not the human body has fallen; and

a moving distance detection unit that calculates, when it is determined that there results fallen state, a moving distance of the partial image included in the human body image on the basis of the position coordinate information and position coordinate information acquired in the past, compares the moving distance and a threshold value, to detect, on the basis of the compared result, whether or not the moving distance of the partial image indicating the human body is smaller than the threshold value, when the moving distance is small, and detects that the human body included in the human body image has fallen.

It is to be noted that the same object may be attained also by means of a computer program for realizing, by using computer, the fall detection device and the fall detection method which have the above-described components, and a readable storage medium where such computer program is stored.

### Advantageous Effects of Invention

In accordance with the present invention can provide a fall detection device and the like such that even when a video with a low frame rate is used, and a CPU that demonstrates inferior performance is employed, it is possible to detect, with a higher accuracy, that a human body has fallen.

### BRIEF DESCRIPTION OF DRAWINGS

FIG. 1 is a block diagram showing the configuration of a fall detection device in a first exemplary embodiment of the present invention.

FIG. 2A is a diagram illustrating a human body image indicating “fallen state” obtained through experiencing learning by any statistical pattern recognition technique in generating an appearance dictionary in the first exemplary embodiment of the present invention.

FIG. 2B is a diagram illustrating a human body image indicating “fallen state” obtained through experiencing learning by any statistical pattern recognition technique in generating an appearance dictionary in the first exemplary embodiment of the present invention.

FIG. 2C is a diagram illustrating a human body image indicating “non-fallen state” obtained through experiencing learning by any statistical pattern recognition technique in generating an appearance dictionary in the first exemplary embodiment of the present invention.

FIG. 2D is a diagram illustrating a human body image indicating “non-fallen state” obtained through experiencing learning by any statistical pattern recognition technique in generating an appearance dictionary in the first exemplary embodiment of the present invention.

FIG. 3A is a diagram illustrating a human body image indicating “fallen state” assumed in generating an appearance dictionary in the first exemplary embodiment of the present invention.

FIG. 3B is a diagram illustrating human body image indicating “fallen state” assumed in generating an appearance dictionary in the first exemplary embodiment of the present invention.

FIG. 3C is a diagram illustrating a human body image indicating “fallen state” assumed in generating an appearance dictionary in the first exemplary embodiment of the present invention.

FIG. 3D is a diagram illustrating a human body image indicating “fallen state” assumed in generating an appearance dictionary in the first exemplary embodiment of the present invention.

FIG. 3E is a diagram illustrating a human body image indicating “fallen state” assumed in generating an appearance dictionary in the first exemplary embodiment of the present invention.

FIG. 3F is a diagram illustrating a human body image indicating “fallen state” assumed in generating an appearance dictionary in the first exemplary embodiment of the present invention.

FIG. 4 is a flowchart showing the operation that the fall detection device in the first exemplary embodiment of the present invention performs.

FIG. 5 is a block diagram showing the configuration of a fall detection device in a second exemplary embodiment of the present invention.

FIG. 6 is a flowchart showing the operation that the fall detection device in the second exemplary embodiment of the present invention performs.

FIG. 7 is a block diagram showing the configuration of a fall detection device in a third exemplary embodiment of the present invention.

FIG. 8A is a diagram illustrating “non-fallen state” obtained through experiencing learning in generating appearance dictionary in the third exemplary embodiment of the present invention.

FIG. 8B is a diagram illustrating “fallen state” obtained through experiencing learning in generating appearance dictionary in the third exemplary embodiment of the present invention.

FIG. 9A is a diagram illustrating an exemplary embodiment in which the illustration of “non-fallen state” obtained through experiencing learning in appearance dictionary in the third exemplary embodiment of the present invention are divided into areas for respective appearances (area divisional example 1).

FIG. 9B is a diagram illustrating an exemplary embodiment in which the illustration of “non-fallen state” obtained through experiencing learning in appearance dictionary in the third exemplary embodiment of the present invention are divided into areas for respective appearances (area divisional example 2).

FIG. 10 is a block diagram showing the configuration of a fall detection device in a modified example of the third exemplary embodiment of the present invention.

FIG. 11 is a block diagram for exemplarily describing a hard ware configuration of an information processing equipment which can realize the respective exemplary embodiments according to the present invention.

### DESCRIPTION OF EMBODIMENTS

Exemplary embodiments of the present invention will now be described in detail with reference to the attached drawings.

### First Exemplary Embodiment

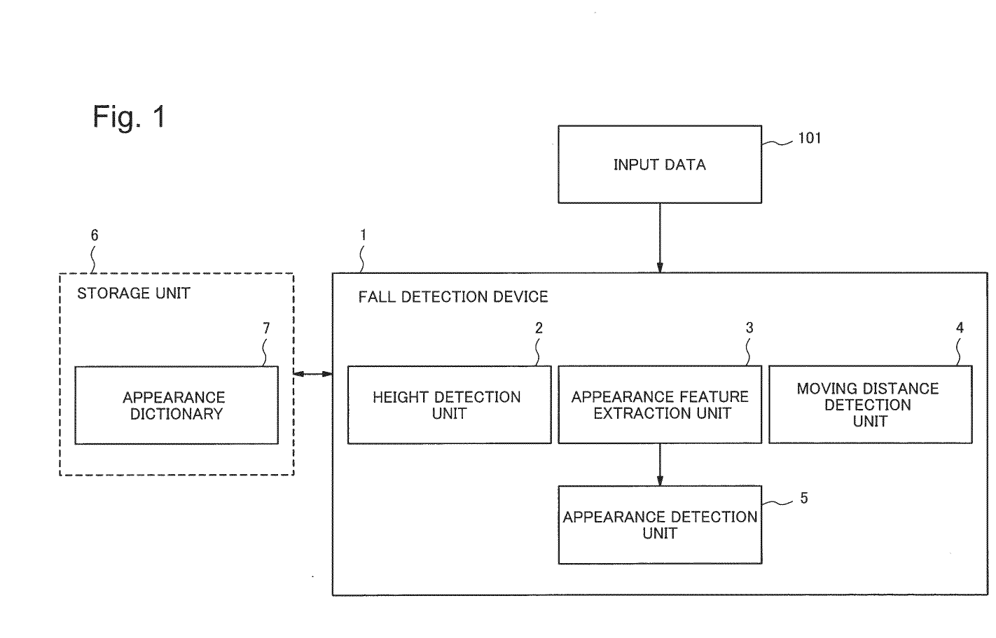

FIG. 1 is a block diagram showing the configuration of a fall detection device 1 in a first exemplary embodiment of the present invention.

In FIG. 1, the fall detection device 1 includes a height detection unit 2, an appearance feature extraction unit 3, a moving distance detection unit 4, and an appearance detection unit 5.

In the following description, for convenience of explanation, height information newly input to the height detection unit 2 will be referred to as “first height information”. Moreover, in the following description, height information input in the past to the height detection unit 2 will be referred to as “second height information”. In the following description, position coordinate information indicating position on the coordinate of a partial image indicating a human body newly input to the moving distance detection unit 4 will be referred to as “first position coordinate information”. In addition, in the following description, position coordinate information indicating position on the coordinate of the partial image indicating a human body input in the past to the moving distance detection unit 4 will be referred to as “second position coordinate information”. (This applies also in the following exemplary embodiments).

In this case, height information (first height information, second height information) are information indicating the height of the human body included in the human body image.

It is to be noted that, for height information (first height information, second height information), there may be used, e.g., the number of pixels in a height direction of the partial image indicating the human body included in the human body image. Moreover, for such height information, aspect ratio of the partial image included in the human body image may be used. Further, for height information, there may be used a height (meter) in actual three-dimensional space information, calculable based on parameters of a camera adapted to take an image (video), which parameters have been calculated in advance. Alternatively, for height information, there may be used aspect ratio of the human body within an actual three-dimensional space. It is to be noted that the present invention exemplified by the embodiments is not limited to the previously described configuration (This applies also in the following exemplary embodiments).

More specifically, the height detection unit 2 compares first height information newly input and second height information input in the past to thereby detect that the height of the human body decreases.

Thus, the height detection unit 2 compares the first height information newly input and the second height information input in the past. As a result, when the height detection unit 2 determines that the first height information decreases with respect to the second height information, it detects that the height of the human body decreases.

As an example, the human body image is a motion image consisting of a plurality of image frames in time series including the partial image indicating the human body to be detected, which has been taken by an imaging device such as a camera.

The appearance feature extraction unit 3 extracts, on the basis of input appearances of the human body image (hereinafter they may be represented as “way of seeing” or “appearance”), feature (appearance feature) relating to the human body image.

More specifically, as an example, the appearance feature extraction unit 3 may extract appearance feature by making use of luminance value of the input human body image.

Further, the appearance feature extraction unit 3 may extract appearance feature by making use of HOG (Histograms_of_oriented_gradients) described in, for example, N. Daral B Trggs “Histograms_of_oriented_gradients_for_human_detection”, In_Proceeding_of_the_CVPR'05 vol. 1, pp. 886-893, 2005.

In addition, the appearance feature extraction unit 3 may utilize, as the appearance feature, amount of characteristics in gradients orientation of normalized amalgamation type described in e.g., Toshinori Hosoi, Nagaki Ishidera “An object classification method based on moving region's appearance, Forum on Information Technology 2006, Glossary of Papers of General meeting, No. 3 Separate Volume, pp. 71-72, 2006 (This applies also in the following exemplary embodiments).

It is to be noted that, for the extraction technique itself employed when the above-described appearance feature extraction unit 3 extracts an appearance feature, common technologies currently used may be adopted. For this reason, the detailed description in this exemplary embodiment may be omitted (This applies also in the following exemplary embodiments).

Next, the appearance detection unit 5 determines the state of the human body to be detected (“fallen state” or “the non-fallen state) on the basis of appearance feature extracted by the appearance feature extraction unit 3 and an appearance dictionary 7 (hereinafter referred to as “first appearance dictionary” as occasion demands) (determination processing).

It should be further noted that the appearance detection unit 5 and the appearance dictionary 7 will be described later.

The appearance detection unit 5 makes reference to the appearance dictionary 7 on the basis of appearance feature. Further, the appearance detection unit 5 determines the state of the human body to be detected (“fallen state” or “non-fallen state”) on the basis of the result that reference has been made to the appearance dictionary 7.

The moving distance detection unit 4 calculates, on the basis of first position coordinate information newly input and second position coordinate information input in the past, a distance which the human body moved (moving distance). Thus, the moving distance detection unit 4 calculates the moving distance of the partial image included in the human body image on the basis of the first position coordinate information and the second position coordinate information.

Next, the moving distance detection unit 4 compares the calculated moving distance and a threshold value which is set in advance at the moving distance detection unit 4. Then, the moving distance detection unit 4 detects, on the basis of comparison result thereof, that the moving distance (movement amount) of the human body included in the human body image is small.

It is to be noted that, e.g., the moving distance, a moving distance may be calculated by using position information of the planar (two-dimensional) coordinate system in the human body image. Alternatively, the moving distance, a moving distance may be calculated by using position information in an actual three-dimensional space coordinate system. It is further noted that the present invention exemplified by this exemplary embodiment is not limited to the previously described configuration (This applies also in the following exemplary embodiments).

Moreover, as an example, for the threshold value, there may be employed a value obtained by calculating, by a predetermined calculation, a moving distance per unit time. Further, time information may be added to the threshold value and the position coordinate information. Thus, when the moving distance is continuously small for a predetermined time, the moving distance detection unit 4 can detect that the moving distance is small. It is to be noted that the present invention exemplified by this exemplary embodiment is not limited to the previously described configuration. (This applies also in the exemplary embodiments).

Moreover, for the technology itself in which the above-described moving distance detection unit 4 calculates the moving distance of the partial image included in the human body image on the basis of the first position coordinate information and the second position coordinate information, common technologies currently used may be adopted. For this reason, the detailed description in this exemplary embodiment will be omitted (This applies also in the following exemplary embodiments).

A storage unit 6 may be a non-volatile memory device in which data read/write operations can be made by computer. More specifically, as an example, for the storage unit 6, there may be employed any non-volatile memory device such as Hard Disk Drive (hereinafter referred to as “HDD”) mounted within an electronic equipment such as a server.

Moreover, for example, for the storage unit 6, there may be adopted any storage device (not shown) connected to communication network (not shown). It is to be noted that the present invention exemplified by this exemplary embodiment is not limited to the previously described configuration (This applies also in the following exemplary embodiments).

The appearance dictionary 7 generated through experiencing learning relating to the state of the human body to be detected (“fallen state” or “non-fallen state”) is stored in advance on the storage unit 6.

The appearance dictionary 7 mentioned here is a set of parameter values (appearance features) required in performing determination processing the state of the human body to be detected.

Moreover, for the learning and the determination processing technique by the appearance detection unit 5, there may be employed any statistical pattern recognition technique.

More specifically, as an example, as the learning and the determination processing technique for the appearance detection unit 5, there may be employed Support_Vector_Machine (hereinafter referred to as “SVM”)

Further, for example, the technique, there may be employed Generalized Learning Vector Quantization described in A. Sato K. Yamada “Generalized_Learning_Vector_Quantization”, Advance_In_Neural Information Processing Systems, Vol. 8, pp. 423-429, MIT Press, 1996.

More specifically, as an example, when the Generalized Learning Vector Quantization is used, a group of reference vectors obtained as the result of learning and class information to which respective reference vectors belong are stored in appearance dictionary 7.

It is to be noted that the appearance feature changes depending upon the positional relationship between the human body to be detected and an imaging camera.

More specifically, for example, a video (image) obtained by imaging the human body to be detected by means of a camera installed on a ceiling so that the angle of view is directed vertically and the video (image) obtained by imaging such the human body by means of cameras installed on (floors and horizontal) walls so that the angle of view is directed laterally are greatly different in appearance of the human body. For this reason, the appearance dictionary 7 may be generated by using appearance data corresponding to the environment to which the present invention is intended to be applied.

The operation of more practical fall detection device 1 according to the first exemplary embodiment of the present invention will now be described.

In the following description, the operation when input data 101 is input to the fall detection device 1 as an example will be described in detail.

It is assumed that the input data 101 is “human body image”, and “human position coordinate information” which are obtained by a predetermined processing on the basis of “human body image” and “human size (height) information”.

It is to be noted that, for the technology itself for determining the “human position coordinate information” and the “human size (height) information” on the basis of the “human body image”, common technologies currently used may be employed. For this reason, the detailed description in this exemplary embodiment will be omitted (This applies also in the following exemplary embodiments).

It is to be noted that while the above-described configuration will be used as an example for convenience of the description, the present invention is not limited to such configuration (This applies also in the following exemplary embodiments).

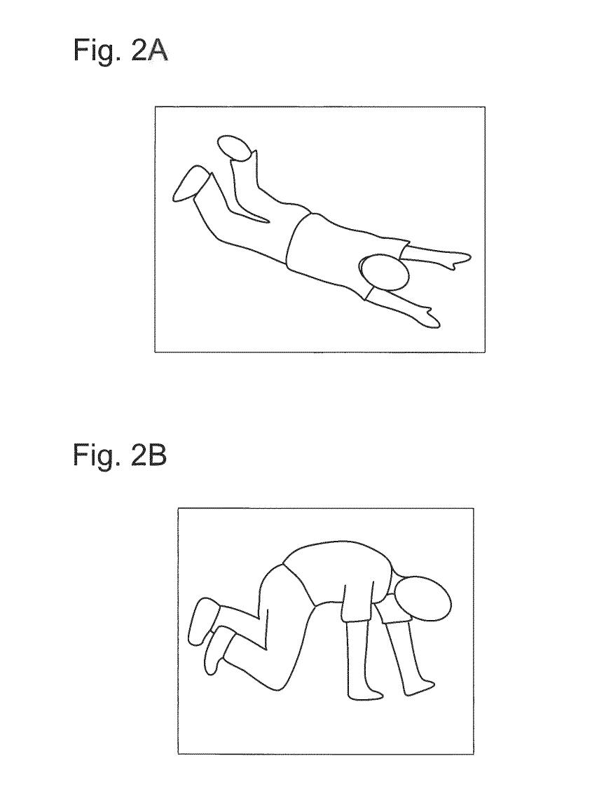

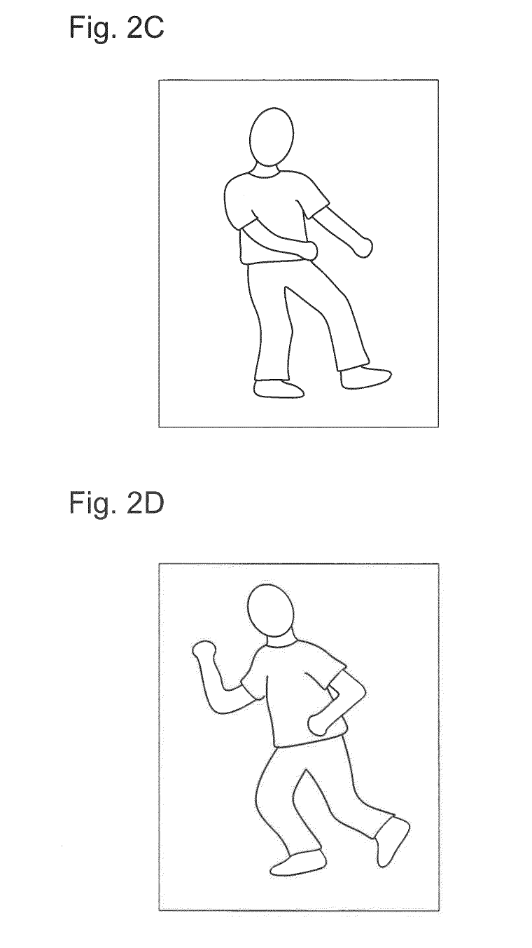

FIGS. 2A to 2d are diagrams illustrating human body images indicating “fallen state” and “non-fallen state” which are learned by any statistical pattern recognition technique in generating the appearance dictionary 7 in the first exemplary embodiment of the present invention.

Specifically, FIGS. 2A and 2B are diagrams respectively illustrating human body images indicating an assumed “fallen state”. FIGS. 2C and 2D are diagrams respectively illustrating human body images indicating an assumed “non-fallen state”.

First, the appearance dictionary 7 generated prior to processing is stored in the storage unit 6 in advance.

More specifically, the appearance dictionary 7 generates “human body attitudes” indicating “fallen state” and “non-fallen state” on the basis of a plurality of human images illustrated in FIG. 2. In that case, the appearance dictionary 7 is generated through experiencing learning by using any statistical pattern recognition technique on the basis of the large number of human body images.

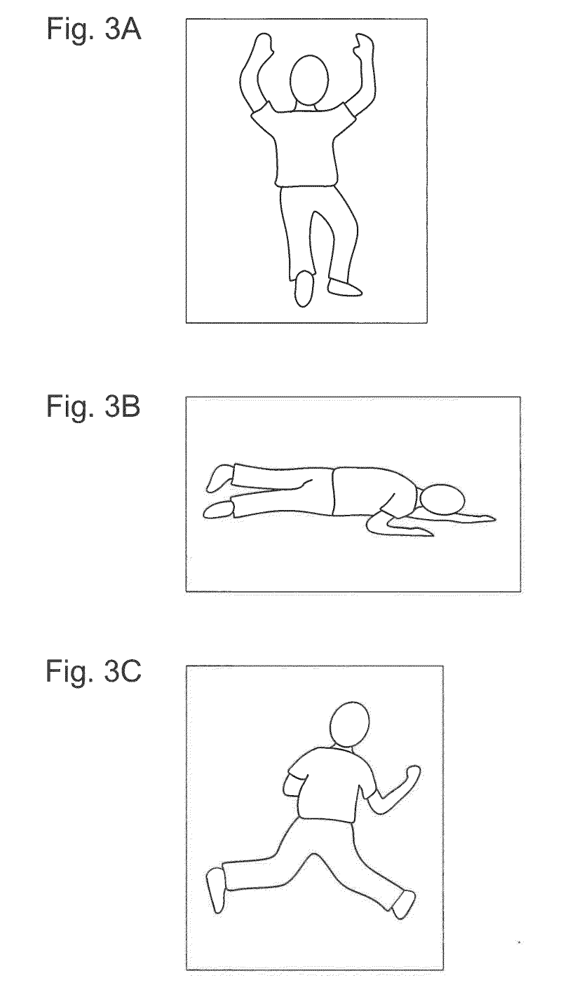

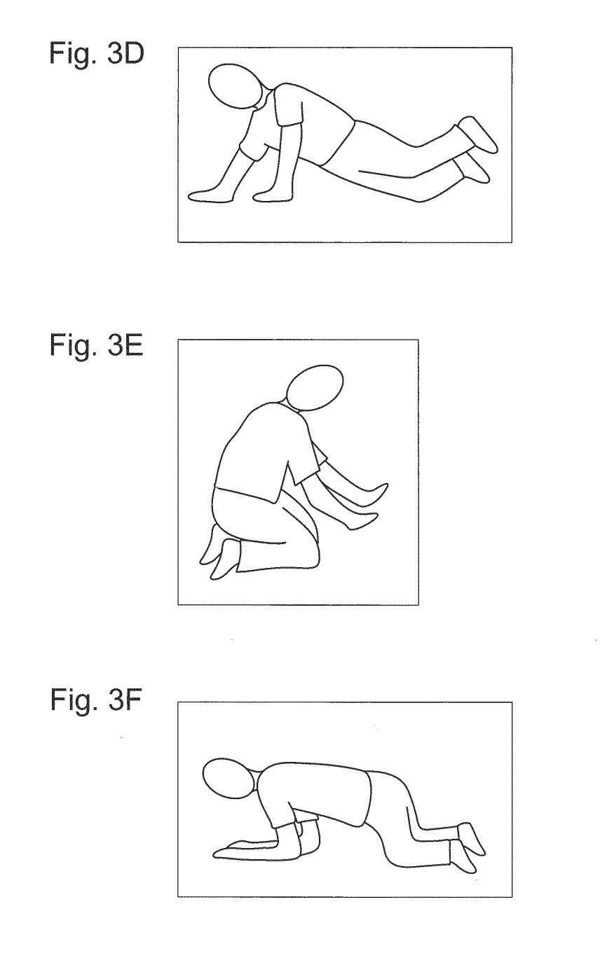

FIGS. 3A to 3F are diagrams illustrating the human body image indicating assumed “fallen state” in generating the appearance dictionary 7 in the first exemplary embodiment of the present invention.

As an example mentioned here, as an image indicating “fallen state” used for learning, it is desirable to exhaustively utilize the large number of human images in which “human body” to be detected are illustrated in FIGS. 3A to 3C.

Further, for an image indicating “fallen state” used for learning, “human body attitude” of going to fall illustrated in FIGS. 3D to 3F may be also utilized as the human body image indicating “fallen state”.

More specifically, as an example, various patterns including not only the state where the human body lies, but also the case, for example, where it sits down on the floor (ground) with his both hands being in touch therewith. are assumed as such “fallen state”. For this reason, for an image indicating “fallen state” used for learning in generating the appearance dictionary 7, “human attitude” of going to fall, which is illustrated in FIGS. 3D to 3F, may be learned as “fallen state”. Thus, the fall detection device 1 can determine the “fallen state” of the human body with high accuracy.

It should be noted that “human attitudes” illustrated in FIGS. 2 and 3 have been described in the above-described exemplary embodiment as an example. However, the present invention is not limited to such an implementation. For learning, it is desirable to utilize the large number of human body images indicating “human body attitude” of various patterns such as a case of falling with its arms spread. (This also in the following exemplary embodiments).

In this way, in generating the appearance dictionary 7, the fall detection device 1 in this exemplary embodiment can determine between various “human attitudes” by adjusting (learning) “human body attitude” to be detected.

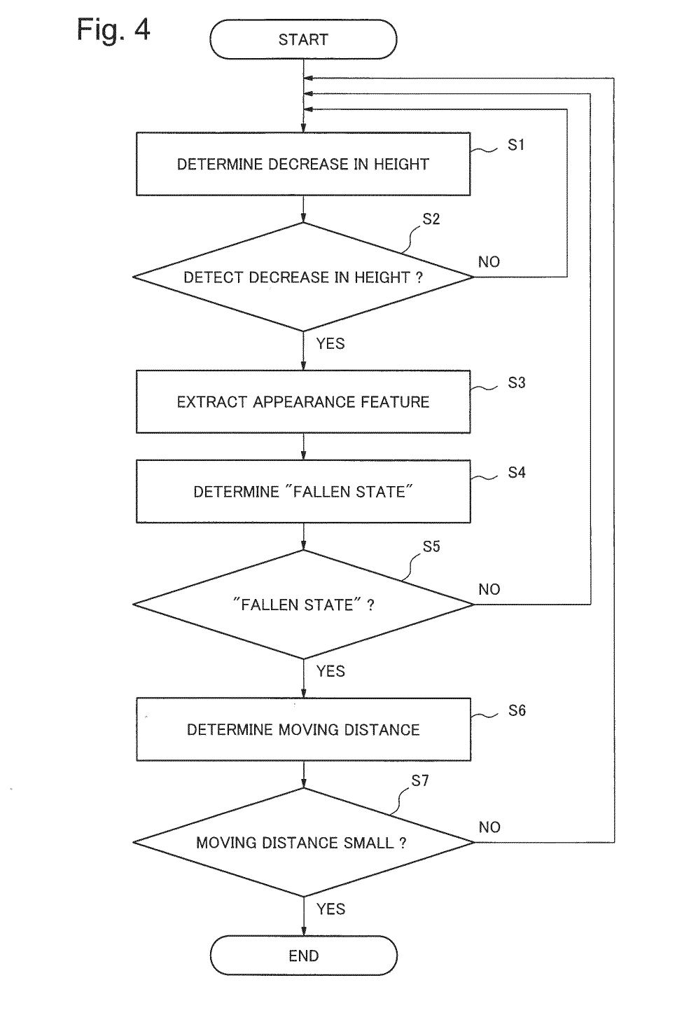

FIG. 4 is a flowchart showing the operation that the fall detection device 1 in this exemplary embodiment of the present invention performs. The operation procedure of the fall detection device 1 will be described according to such the flowchart.

### Step S1:

The fall detection device 1 executes a process step by the height detection unit 2 in response to input of input data 101.

The height detection unit 2 detects, on the basis of “size (height) information” included in the input data 101, whether or not the height of the human body to be detected decreases.

More specifically, the height detection unit 2 compares “size (height) information of the human body” in a frame which has been newly input (first height information) and “size (height) information of the human body” in a frame input in the past (second height information) to thereby detect that the height of the human body decreases.

### “No” in Step S2:

When the height detection unit 2 detects that the height of the human body to be detected does not decrease, this process step is stopped. Thus, the process step by the height detection unit 2 proceeds to processing the next video frame.

### “Yes” in the Step S2:

When the height detection unit 2 detects that the height of the human body to be detected decreases, the process step by the height detection unit 2 proceeds to step S3.

### Step S3:

The appearance feature extraction unit 3 extracts appearance feature on the basis of “human body image” included in the input data 101.

### Step S4:

The appearance detection unit 5 determines the state of the human body to be detected (“fallen state” or “non-fallen state”) on the basis of the appearance dictionary 7 stored in advance in the storage unit 6 and the appearance feature extracted by the appearance feature extraction unit 3.

More specifically, as an example, explanation in the following description will be given in connection with the case where a group of reference vectors are stored in the storage unit 6 as the appearance dictionary generated using the above-described generalized learning vector quantization. The appearance detection unit 5 assumes the appearance feature extracted by the appearance feature extraction unit 3 as a vector (feature vector).

Further, the appearance detection unit 5 performs the nearest neighbor search with respect to the group of reference vectors to determine into class to which the nearest neighbor vector belongs (“fallen state” or “non-fallen state”).

### “NO” in Step S5:

When the appearance detection unit 5 determines that the human body to be detected is “non-fallen state”, this process step is stopped. The process step by the appearance detection unit 5 proceeds to processing the next video frame.

“YES” in step S5:

When it has been determined that the human body to be detected is “fallen state”, the process step by the appearance detection unit 5 proceeds to step S6.

### Step S6:

The moving distance detection unit 4 calculates, on the basis of “position coordinate information of the human body” included in the input data 101, a distance which the human body to be detected moved. Then, the moving distance detection unit 4 compares the calculated moving distance and the threshold value which is set at the moving distance detection unit 4 in advance. The moving distance detection unit 4 detects, on the basis of the comparison result, that the moving distance of the human body is small.

More specifically, the moving distance detection unit 4 calculates the distance of the human body to be detected on the basis of “position coordinate information of the human body” in a frame newly input (first position coordinate information) and “position coordinate information of the human body” in a frame input in the past (second position coordinate information).

Then, the moving distance detection unit 4 compares the calculated moving distance and the threshold value which is set at the moving distance detection unit 4 in advance. The moving distance detection unit 4 detects, on the basis of the comparison result, that the moving distance of the human body is small.

“NO” in step S7:

When the moving distance detection unit 4 does not detect that the moving distance of the human body to be detected is smaller than the threshold value, this process step is stopped. Thus, the process step by the moving distance detection unit 4 proceeds to processing the next video frame.

“YES” in step S7:

When the moving distance detection unit 4 detects that the moving distance of the human body to be detected is smaller than the threshold value, it determines that the human body to be detected is in “fallen state”. Thus, the moving distance detection unit 4 detects that the human body to be detected has fallen.

It is to be noted that, for convenience of explanation, the fall detection device 1 allowed the process to proceed in the order of the height detection unit 2, the appearance detection unit 2, and the moving distance detection unit 4. However, the exemplary embodiment of the present invention is not limited to such implementation. For the fall detection device 1, as long as three (the height detection unit 2, the appearance detection unit 5, the moving distance detection unit 4) process are performed, the process sequence is not limited to the above-described order.

It is to be noted that the above-described first exemplary embodiment may be applied to electronic equipment such as a server or a personal computer, or may be applied to imaging equipment such as a camera. It is to be noted that the present invention exemplified by this exemplary embodiment is not limited to the previously described configuration (This similarly applies also in the following exemplary embodiments)

As described above, in accordance with the fall detection device 1 according to this exemplary embodiment, even when a video with low frame rate is used, and a CPU that demonstrates inferior performance is employed, it is possible to detect, with a higher accuracy, that the human body has fallen. The reason thereof will be described as follows.

More specifically, this is because the fall detection device 1 determines the state of the person to be detected on the basis of detection and determination results from the height detection unit 2, the appearance detection unit 5 and the moving distance detection unit 4.

Particularly, the appearance may include information sufficient for determining the state of the human body (“fallen state” or “non-fallen state”). Further, the appearance treats a simple determination problem of the state of the human body to be detected (“fallen state” or “non-fallen state”. For this reason, information (appearance feature) for performing determination, with a high accuracy, are stored in appearance dictionary 7 by learning on the basis of the appearance. As a result, the appearance detection unit 5 can provide a high determination accuracy.

Further, the fall detection device 1 is not required to detect motion in the act of falling of the human body to be detected, it is possible to detect “fallen state” of the human body by using the video with low frame rate.

More specifically, in the height detection unit 2, as an example, as long as respective single frames before and after the fall of the human body to be detected exist, it is possible to detect the fall of the human body to be detected. Moreover, in the appearance detection unit 5, as long as respective single frames before and after the fall of the human body to be detected exist, it is possible to determine the fall of the human body to be detected. Further, in the moving distance detection unit 4, as long as respective single frames before and after the fall exist, it is possible to detect the fall of the human body to be detected.

Further, the fall detection device 1 can execute, with a smaller amount of calculation (low processing capability), process steps at the height detection unit 2, the appearance detection unit 2 and the appearance detection unit 5, and the moving distance detection unit 4. Thus, the fall detection device 1 can detect fall of the human body to be detected with a small amount of process steps.

More specifically, as an example, the height detection unit 2 compares the first height information newly input and the second height information input in the past to thereby detect that the height of the human body decreases. For this reason, the processing is lightly loaded. Moreover, the appearance detection unit 5 extracts appearance feature on the basis of the input human body image. The appearance detection unit 5 performs determination on the basis of the extracted appearance feature and the appearance dictionary 7 stored in advance. For this reason, the appearance detection unit 5 need not any complicated processing. Further, the moving distance detection unit 4 calculates, on the basis of the first position coordinate information newly input and the second position coordinate information input in the past, a distance which the human body to be detected moved. The moving distance detection unit 4 detects, on the basis of the result obtained by comparing the calculated moving distance and the threshold value which is set in advance, that the moving distance of the human body is smaller than the threshold value. Therefore, the processing is lightly loaded.

### Second Exemplary Embodiment

A second exemplary embodiment based on the fall detection device 1 according to the above-described first exemplary embodiment of the present invention will now be described. In the following description, the characteristic part according to this exemplary embodiment will be mainly described. In this instance, the same reference numerals are assigned to the components similar to those of the respective exemplary embodiments to thereby omit repetitive explanations thereof.

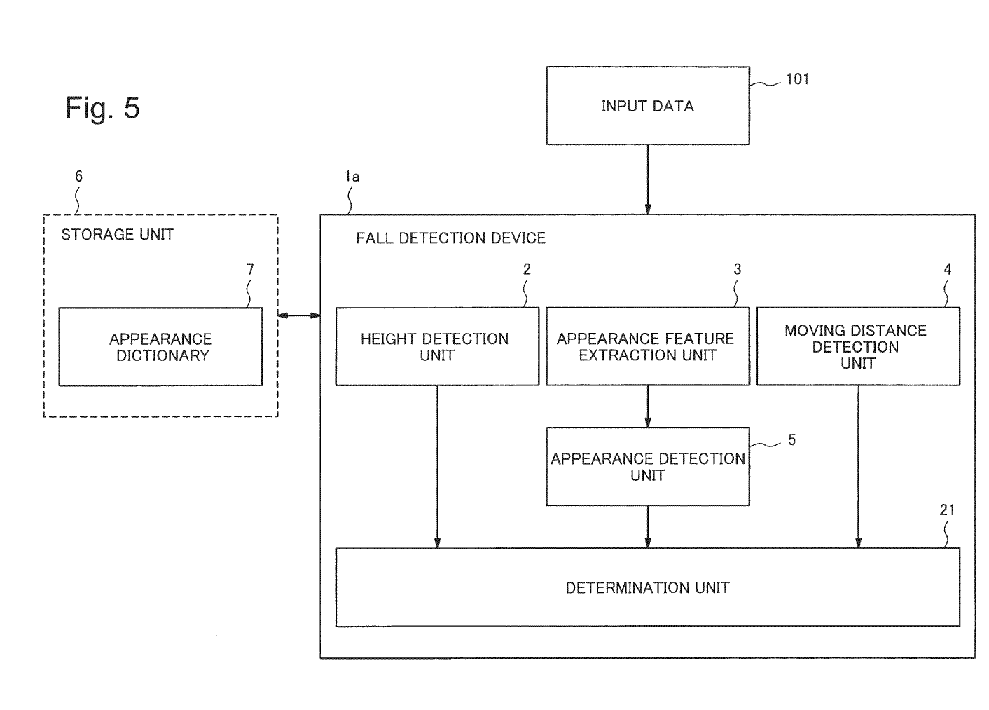

A fall detection device 1a in the second embodiment of the present invention will now be described with reference to FIG. 5.

FIG. 5 is a block diagram showing the configuration of the fall detection device 1a in the second exemplary embodiment of the present invention.

In FIG. 5, the fall detection device 1a includes the height detection unit 2, the appearance feature extraction unit 3, the moving distance detection unit 4 and a determination unit 21.

In this exemplary embodiment, the case where the determination unit 21 is further applied to the fall detection device 1 in the first exemplary embodiment will be described.

The determination unit 21 acquires the result obtained by detection and determination in the process of the height detection unit 2, the appearance detection unit 5 and the moving distance detection unit 4. The determination unit 21 comprehensively determines the result thus acquired by the height detection unit 2, the appearance detection unit 5, and the moving distance detection unit 4. Thus, the determination unit 21 detects, on the basis of respective results by the height detection unit 2, the appearance detection unit 5 and the moving distance detection unit 4, whether or not the human body to be detected is fallen.

More specifically, as an example, the determination unit 21 acquires detection or determination from the height detection unit 2, the appearance detection unit 5 and the moving distance detection unit 4.

The determination unit 21 detects that the human body to be detected has fallen in the following case:

the result acquired from height detection unit 2 is information indicating that “the height of the human body decreases”;

the result acquired from the appearance detection unit 5 is information indicating “fallen state”; and

the result acquired from the moving distance detecting unit 4 is information indicating “the moving distance of the human body is small”.

On one hand, when the determination unit 21 detects that the human body to be detected is not fallen, this process step is stopped. The process by the determination unit 21 proceeds to processing the next video frame.

It is to be noted that, as an example, the determination unit 2 has detected that the human body to be detected has fallen in the following case: the result acquired from the height detection unit 2 is information indicating that “the height of the human body decreases”;

the result acquired from the appearance detection unit 5 is information indicating “fallen state”, and

the result acquired from the moving distance detection unit 4 is information indicating that “moving distance of the human body is small”.

However, the present invention is not limited to such implementation. The determination unit 21 may detect that the human body to be detected has fallen in the following case:

the result acquired from the height detection unit 2 is information indicating that “the height of the human body does not decrease”;

the result acquired from the appearance detection unit 5 is information indicating (fallen state), and

the result acquired from the moving distance detection unit 4 is information indicating that “moving distance of the human body is small.

As described above, the condition where the determination unit 21 detects may be changed so as to be able to detect that the human body to be detected falls (This applies also in the following exemplary embodiments).

The operation of a more specific fall detection device 1a according to the second exemplary embodiment of the present invention will now be described.

In the following description, the operation when input data 101 is input to the fall detection device 1a as an example will be described in detail

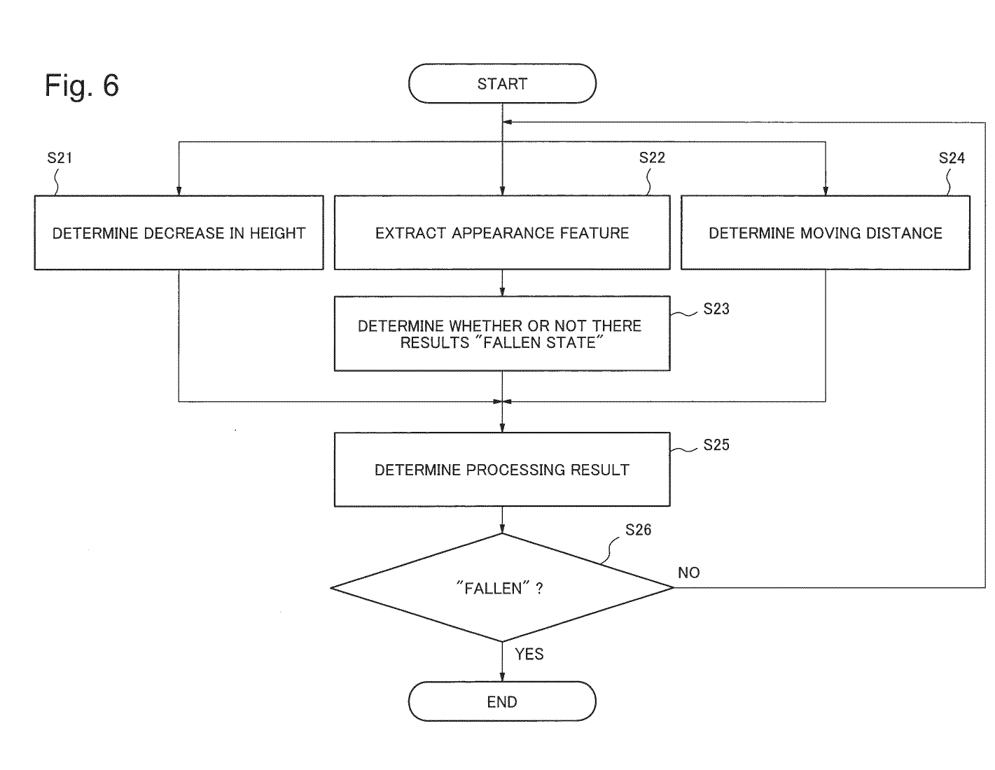

FIG. 6 is a flowchart showing the operation that the fall detection device 1a in the second exemplary embodiment performs. The operation procedure of the fall detection device 1a will be described in accordance with the flowchart.

### Step S21:

The fall detection device 1a executes a process step by the height detection unit 2 in accordance with input of input data 101.

The height detection unit 2 detects, on the basis of “size (height) information of the human body” included in the input data 101, whether or not the height of the human body to be detected decreases.

Then, the detection unit 2 inputs (gives) the detected result to the determination unit 21.

Here, it is assumed that the height detection unit 2 inputs, to the determination unit 21, information indicating that “the height of the human is being decreased” which is the detected result.

### Step S22:

The appearance feature extraction unit 3 extracts appearance feature on the basis of “human body image” included in input data 101.

### Step S23:

The appearance detection unit 5 determines the state of a human body to be detected (“fallen state” or “non-fallen state”) on the basis of appearance dictionary 7 stored in advance in the storage unit 6, and the appearance feature extracted by the appearance feature extraction unit 3.

Then, the appearance detection unit 5 inputs the determined result to the determination unit 21.

Here, it is assumed that the appearance detection unit 5 inputs, to the determination unit 21, information indicating that “fallen state” which is the determined result.

### Step S24:

The moving distance detection unit 4 calculates, on the basis of “position coordinate information of the human body” included in the input data 101, a distance which the human body to be detected moved. Next, the moving distance detection unit 4 compares the calculated moving distance and the threshold value which is set in advance. The moving distance detecting unit 4 detects, on the basis of the compared result, that the moving distance of the human body is smaller than the threshold value.

The moving distance detection unit 4 inputs the detected result to the determination unit 21.

Here, it is assumed that the moving distance detection unit 4 inputs, to the determination unit 21, information indicating that “the moving distance of the human body is small” which is the detected result.

### Step S25:

The determination unit 21 determines, in accordance with the result input from the height detection unit 2, the appearance detection unit 5 and the moving distance detection unit 4, whether or not the human body to be detected has fallen.

Here, the result that the determination unit 21 acquires is as follows:

information indicating that “the height of the human body decreases” from the height detection unit 2;

information indicating “fallen state” from the appearance detection unit 5, and

information indicating that “moving distance of the human body is small” from the moving distance detection unit 4.

### “NO” in Step S26:

When the determination unit 21 determines, from the result obtained by determining whether or not the human body to be detected has fallen, that the human body to be detected does not fallen, this process step is stopped. The process by the determination unit 21 proceeds to processing the next video frame.

### “YES” in Step S26:

When the determination unit 21 determines, from result obtained by determining whether or not the human body to be detected has fallen, that the human body to be detected has fallen, it is detected that the human body to be detected has fallen.

It is to be noted that the process steps at the height detection unit 2, the appearance detection unit 5, and the moving distance detection unit 4 may be executed substantially in parallel, or may be sequentially executed. In these case, the same results may be all provided as the detection results.

More specifically, in performing substantially parallel-running on electronic equipment such as a personal computer or a server, having processor including a plurality of arithmetic cores (multicore processor) mounted therein, the fall detection device 1a can execute, at a higher speed, respective process steps at the height detection unit 2, the appearance detection unit 5 and the moving distance detection unit 4. It is to be noted that the present invention exemplified by this exemplary embodiment is not limited to the previously described configuration. (This applies in the following exemplary embodiment).

Further, for convenience of explanation, as an example, in this exemplary embodiment, process steps at the height detection unit 2, the appearance detection unit 5 and the moving distance detection unit 4 were executed in the fall detection device 1a. However, the present invention is not limited to such an implementation. Respective process steps may be executed substantially in parallel by a plurality of fall detection devices 1a.

In that case, for example, the determination unit 21 acquires detected results or determined results from the height detection unit 2, the appearance detection unit 5 and the moving distance detection unit 4 which are connected through communication network (not illustrated).

The determination unit 21 comprehensively may determine results at the height detection unit 5, the appearance detection unit 2 and the moving distance detection unit 4, which have been acquired to thereby detect whether or not the human body to be detected has fallen (This applies in the following exemplary embodiments).

As described above, in accordance with the fall detection device 1a according to this exemplary embodiment, it is possible to enjoy advantageous effects which have been described in the first exemplary embodiment, and the fall detection device 1a is further able to more rapidly detect that a human body to be detected has fallen. The reason thereof is that the fall detection device 1a further includes determination unit 21. This is because the height detection unit 2, the appearance detection unit 5 and the moving distance detection unit 4 can execute respective process steps without waiting for the completions of each other.

### Third Exemplary Embodiment

A third exemplary embodiment based on the fall detection device 1a according to the above-described present invention will be described. In the following description, the characteristic part of this exemplary embodiment will be mainly described. In this instance, the same reference numerals are respectively assigned to the components similar to those of the above-described exemplary embodiment to thereby omit repetitive explanation thereof.

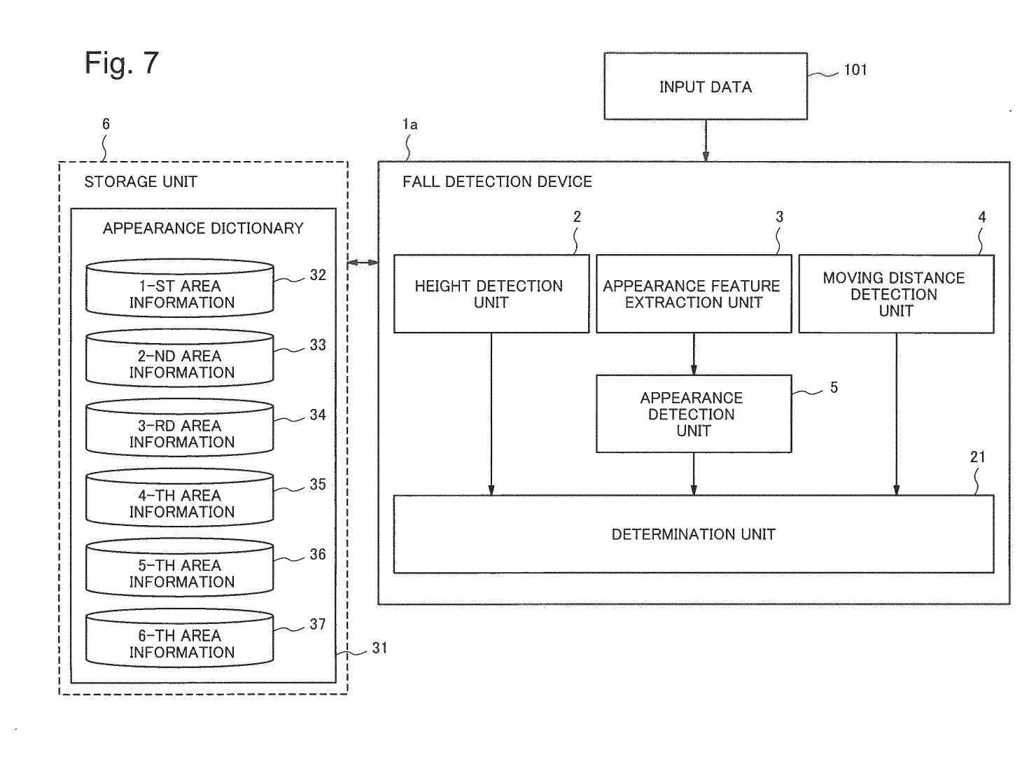

FIG. 7 is a block diagram showing the configuration of fall detection device 1a in the third exemplary embodiment of the present invention.

In FIG. 7, the fall detection unit 1a includes an appearance dictionary 31 (hereinafter may be referred to as “second appearance dictionary” as occasion demands).

In this exemplary embodiment, explanation will be given in connection with the case where the appearance dictionary 31 is further applied to the fall detection device 1a which has been described in the second exemplary embodiment

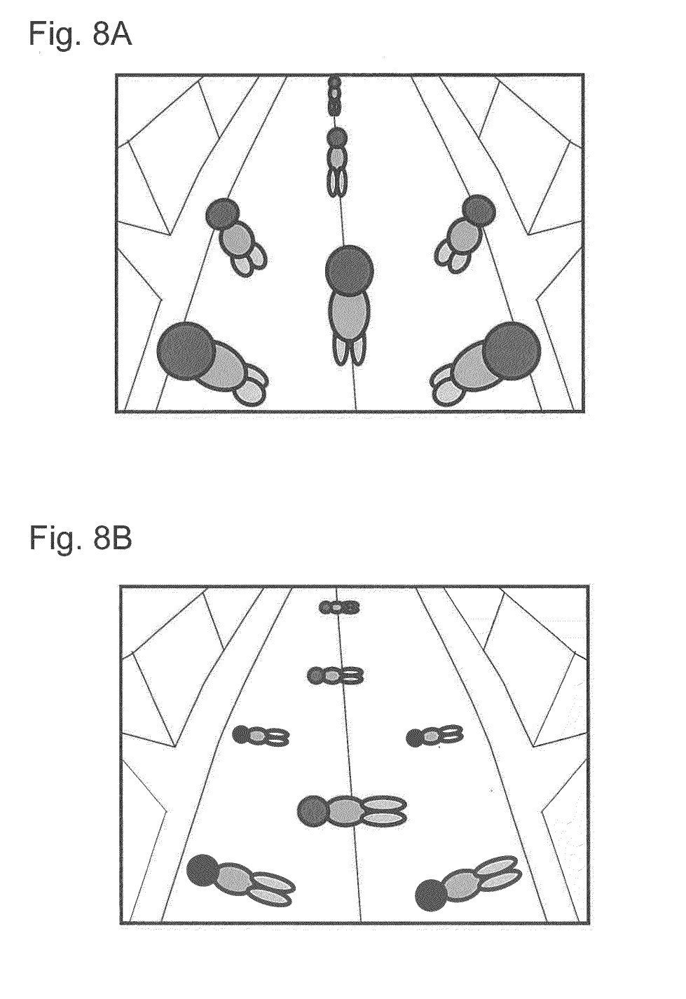

FIGS. 8A and 8B are diagrams illustrating “non-fallen state” (FIG. 8A) and “fallen state” (FIG. 8B) which are learned in generating the appearance dictionary 31 in the third exemplary embodiment of the present invention.

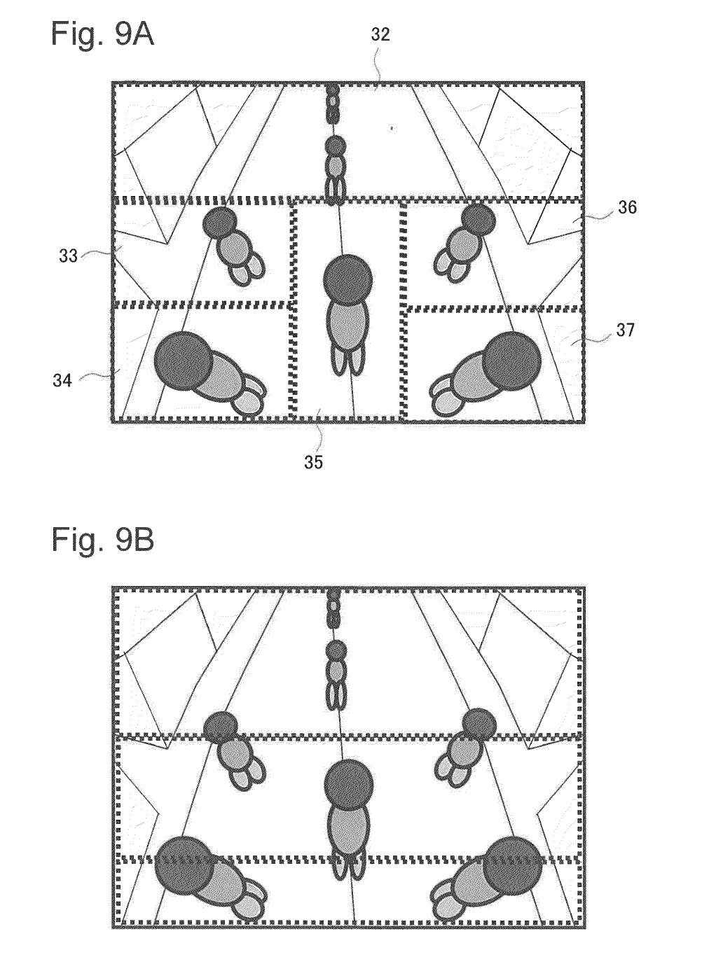

Moreover, FIGS. 9A and 9B are diagrams illustrating the exemplary embodiment in which the illustration of “non-fallen state” to be learned in generating appearance dictionary 31 in the third exemplary embodiment of the present invention is divided into areas for respective appearances.

Here, FIGS. 8A and 8B are diagrams in which the ground in which the persons exists was captured at a downward angle by a camera installed at a higher position. Further, FIG. 8A is a diagram illustrating the human image which indicates assumed “non-fallen state”. In addition, FIG. 8B is the diagram illustrating a human image that indicates assumed “fallen state”.

Moreover, FIG. 9A is a diagram illustrating the exemplary embodiment in which the human body image indicating “non-fallen state” is divided into areas (first area to sixth area) for respective appearances. Further, FIG. 9B is a diagram illustrating the exemplary embodiment in which the human body image is divided into three areas for respective appearances different from that of FIG. 9A.

It is to be noted that, for convenience of explanation, as an example, FIG. 9 shows, in FIGS. 9A and 9B, the exemplary embodiment in which the human body image is divided into areas for respective appearances. However, the present invention is not limited to such implementation. In the present invention, areas may be divided for respective appearances in accordance with appearance of the human image (This applies also in the following exemplary embodiments).

The appearance dictionary 31 includes first (1st) area information 32, second (2nd) area information 33, third (3rd) area information 34, fourth (4th) area information 35, fifth (5th) area information 36 and the sixth (6th) area information 37 which respectively correspond to respective areas divided for the respective above-described appearance.

Here, the first area information 32 to the sixth area information 37 are appearance dictionaries generated by learning, in advance, appearance features observed in respective plural areas divided for respective appearances.

More specifically, as an example, it is assumed that the first area information 32 is generated by learning a plurality of human body images (not illustrated) indicating “fallen state” and “non-fallen state” within the first area shown in FIG. 9A. In that case, the first area information 32 is generated by using the statistical pattern recognition technique on the basis of the larger number of human body images. It is assumed that the second area information 33 to the sixth area information 37 are similarly generated by the above-described technique of generating the first area information 32.

For convenience of explanation, as an example, the appearance dictionary 31 includes the first area information 32 to the sixth area information 37. However, the present invention is not limited to such implementation. The appearance dictionary 31 may include one or more appearance dictionaries depending on appearance of the human body image.

The operation of a more specific detection device 1a according to the third exemplary embodiment will now be described. In the following description, the characteristic part according to this exemplary embodiment will be mainly described.

The appearance detection unit 5 may determine the state of human body to be detected (“fallen state” or “non-fallen state”) on the basis of the following information:

appearance dictionary 31 (the first area information 31 to the sixth area information 37) which has been selected in accordance with the position (area) of the human body (partial image indicating the human body) that “human body image” included in the input data 101″ indicates, and

appearance feature that the appearance feature extraction unit 3 has extracted.

More specifically, as an example, when the position (area) of the human body to be detected is within the third area in FIG. 9A, the appearance detection unit 5 selects the third area information 34 as the appearance dictionary 31.

Further, the appearance detection unit 5 may determine the state of a human body to be detected (fallen state” or non-fallen state”) on the basis of the selected third area information 34 and the extracted appearance feature by the appearance feature extraction unit 3. It is to be noted that the present invention exemplified by this exemplary embodiment is not limited to the above-described configuration (This applies in the following exemplary embodiments).

The appearance dictionary 31 in this exemplary embodiment may be applied to the fall detection unit 1 in the first exemplary embodiment.

As described above, in accordance with the fall detection device 1a according to this exemplary embodiment, it is possible to obtain advantageous effects which have been described in the above-described exemplary embodiments. Further, in accordance with this exemplary embodiment, it is possible to detect, with a higher accuracy, that the human body to be detected has fallen in videos (images) in which appearances are different depending upon the position of the human body to be detected. This is because the appearance dictionary 31 is generated respective plural areas divided for respective appearances. Moreover, the appearance dictionary 31 is stored in advance in the storage unit 6. Next, the fall detection device 1a selects the appearance dictionary utilized in conformity with the position of the human body to be detected. This is because the fall detection device 1a detects the human body to be detected by using the selected appearance dictionary.

For example, when a camera attached lens, which allows a wide-angle imaging, the appearance of the human body varies considerably in dependence upon the position of the human body in a captured video (image). In such a case, the fall detection device 1a in this exemplary embodiment uses appearance dictionaries for respective divided areas, it is possible to detect with a higher accuracy that the human body has fallen.

### Modified Example of the Third Exemplary Embodiment

It is to be noted that a modified example described below may be realized on the basis of the above-described exemplary embodiment. In the following description, characteristic part according to the modified example of this exemplary embodiment will be mainly described. In this instance, the same reference numerals are respectively assigned to the components similar to those of the above-described respective exemplary embodiments to omit repetitive explanations.

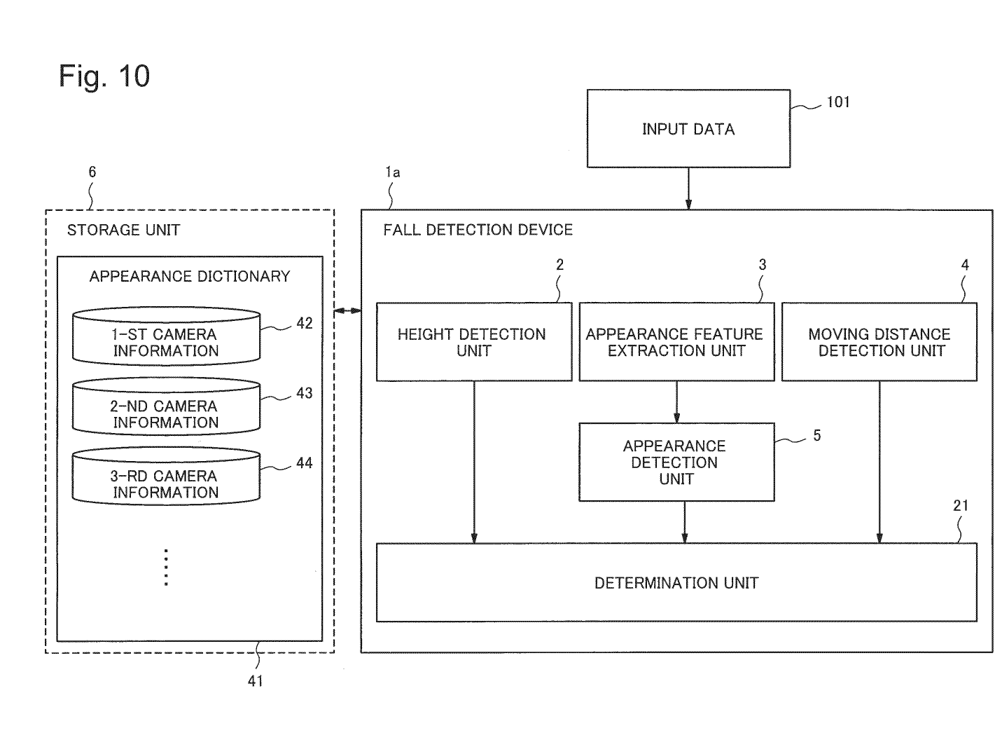

FIG. 10 is a block diagram showing the configuration of fall detection device 1a in the modified example of the third exemplary embodiment of the present invention.

In FIG. 10, the fall detection device 1a includes an appearance dictionary 41 (hereinafter may be referred to as “third appearance dictionary” as occasion demands).

In this modified example, the case where the appearance dictionary 41 is further applied to the fall detection device 1a which has been described in the third exemplary embodiment will be described.

The appearance dictionary 41 includes first (1st) camera information 41, second (2nd) camera information 43 and third (3rd) camera information 44.

Here, the first camera information 42 to the third camera information 44 are appearance dictionary generated by learning, in advance, appearance features observed every condition (installation condition) where the camera is installed.

The installation condition for the camera corresponds to, for example, installation angle of the camera, the background of the video captured by the camera and a distance between the camera and the human body to be detected.

More specifically, as an example, it is assumed that the first camera information 42 is generated by learning a large number of human body images (not illustrated) showing the “fallen state” and the “non-fallen state” photographed under the installation condition for the first camera. In that case, the first camera information 42 is generated by using any statistical pattern recognition technique on the basis of the large number of human body images. It is assumed that the second camera information 43, and the third camera information 44 are similarly generated by a technique of generating the above-described first camera information 42.

For convenience of explanation, as an example, the appearance dictionary 41 includes the first camera information 42, the second camera information 43 and the third camera information 44. However, the present invention is not limited to such implementation. The appearance dictionary 41 may include one or more appearance dictionaries depending upon the installation condition for the camera.

The operation of the more specific fall detection device 1a according to the modified example of the third exemplary embodiment of the present invention. In the following description, characteristic part according to this exemplary embodiment will now be described.

The appearance detection unit 5 may determine the state of the human body to be detected (“fallen state” or “non-fallen state”) on the basis of the appearance dictionary 41 (first camera information 42 to third camera information 44) selected in accordance with the installation condition for the camera that has taken “human body image” included in the input data 101, and the extracted appearance feature that the appearance feature extraction unit 3.

For example, the appearance of the human body in a video (image) in which the human body to be detected is photographed by the camera installed on a ceiling so that the picture angle is directed vertically, and the appearance thereof in the video (image) in which the human body is photographed by the camera installed on (floor and horizontal) walls that the picture angle directed laterally are greatly different.

In such a case, the fall detection device 1a in the modified example selects appearance dictionary to be utilized from appearance dictionaries generated in conformity with the input video (image), and in conformity with the installation condition for a plurality of cameras

Further, the fall detection device 1a can detect the human body to be detected by using the appearance dictionary thus selected. For this reason, processing with respect to videos (images) photographed in various cameras can become possible.

The appearance dictionary 41 in this exemplary embodiment may be applied to the fall detection device 1 in the first exemplary embodiment.

As described above, in accordance with the fall detection device 1a according to this exemplary embodiment, it is possible to obtain advantageous effects which have been described in the above-described respective exemplary embodiments. Further, in accordance with this exemplary embodiment, in videos photographed from various installation angles of camera, it is possible to detect, with a higher accuracy, that the human body to be detected has fallen. The reasons thereof are as follow.

The appearance dictionary 41 is generated respective installation conditions of the plurality of cameras. Further, the appearance dictionary 41 is stored in advance in the storage unit 6.

The fall detection device 1a in the modified example selects the appearance dictionary to be utilized in conformity with the installation condition for camera that has photographed the input human body image. The fall detection device 1a can detect the human body to be detected by using the selected appearance dictionary.

### (Example of Hardware Configuration)

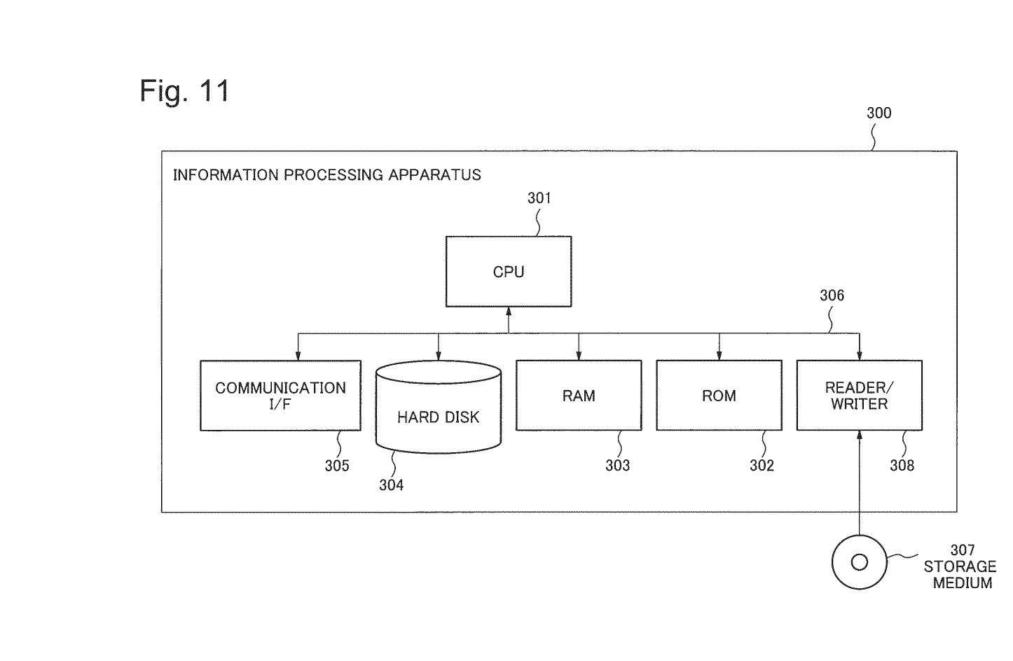

The respective units shown in the drawings of the above-described exemplary embodiments can be grasped as functional (processing) units of software program (software modules). The respective software modules may be realized by dedicated hardware. It is to be noted that while classification of respective units shown in the drawings are configuration for convenience of explanation, various configurations may be assumed in implementation. An example of the hardware environment will be described with reference to FIG. 11.

FIG. 11 is a diagram for exemplarily a configuration of an information processing apparatus 300 (computer) capable of executing the fall detection device according to an exemplary embodiment of the present invention. More specifically, FIG. 11 is the configuration of the computer (information processing apparatus) such as a server which can be capable of executing the entirety of or a part of the fall detection device 1 shown in FIG. 1, or the fall detection device 1a shown in FIG. 5, the fall detection device 1a shown in FIG. 7, and the fall detection device shown in FIG. 10, and represents the hardware environment capable of realizing respective functions in the above-described exemplary embodiments.

The information processing apparatus 300 shown in FIG. 11 is a general computer in which the following components are connected to each other vis a bus 306 (communication line).

CPU (Central_Processing_Unit) 301,

ROM (Read_Only_Memory) 302,

RAM (Random_Access_Memory) 303,

Hard disk 304 (storage device),

Communication Interface (hereinafter referred to as I/F) 305 with external devices, and

Reader/Writer 308 that can read/write operation of data stored in a storage medium 307, such as a CD-ROM (Compact_Disc_Read_Only_Memory).

Further, the present invention which has been exemplified by the above-described exemplary embodiments may be attained by delivering, to the information processing apparatus 300 shown in FIG. 11, a computer program capable of realizing the block diagrams (FIGS. 1, 5, 7, 10) referenced in the description of the equipment, or the functions of the flowcharts (FIGS. 4 and 6) thereafter to read the computer program into the CPU 301 of the hardware to thereby execute it. In addition, the computer program delivered into the equipment may be stored in readable/writable a temporary storage memory (RAM 303) or a non-volatile storage device such as the hard disk 304.

Moreover, in the above-described case, as a method of delivering computer program into the hardware, there may be employed a common procedure currently used described below.

A method for installing into the equipment through respective storage medium 307 such as CD-ROM, and

A method of down-loading from the external through communication line such as Internet. Further, in such a case, it can be grasped that the present invention is composed of codes constituting the computer program, or the storage medium where such codes are stored.

It is to be noted that a part or the entirety of the above-described respective exemplary embodiments and the modified example may be described as in the following supplementary notes. However, the present invention exemplified by the above-described exemplary embodiments and the examples thereof is not limited to the following descriptions. More specifically,

### (Supplementary Note 1)

A fall detection device including:

a height detection unit that detects whether or not a height of a human body to be detected decreases, by comparing, on the basis of a human body image including a partial image indicating the human body, position coordinate information indicating a position on coordinate of the partial image and size information indicating the size of the human body indicated on the partial image, height information included in the size information and height information included in size information acquired in the past;

an appearance feature extraction unit that extracts, when the height decreases, an appearance feature on the basis of appearance of the human body image;

an appearance detection unit that determines, on the basis of a result obtained by making reference to a first appearance dictionary on the basis of the appearance feature, whether or not the human body has fallen; and

a moving distance detection unit that calculates, when it is determined that there results fallen state, a moving distance of the partial image included in the human body image on the basis of the position coordinate information and position coordinate information acquired in the past, compares the moving distance and a threshold value, to detect, on the basis of the compared result, whether or not the moving distance of the partial image indicating the human body is smaller than the threshold value, when the moving distance is small, and detects that the human body included in the human body image has fallen.

### (Supplementary Note 2)

The fall detection device according to the supplementary note 1, further including:

a determination unit that detects whether or not the human body included in the human body image has fallen by performing a determination on the basis of a determination result at the appearance detection unit and a detection result at the moving distance detection unit.

### (Supplementary Note 3)

The fall detection device according to the supplementary note 2, wherein

the determination unit detects that the human body has fallen, when it acquires from the height detection unit, a detection result that the height of the human body decreases, acquires from the appearance detection unit, a determination result that the human body has fallen state, and acquires from the moving distance detection unit, a detection result that the moving distance of the partial image indicating the human body is small.

### (Supplementary Note 4)

The fall detection device according to any one of the supplementary notes 1 to 3, wherein

the appearance detection unit selects a specific appearance dictionary from one or more appearance dictionaries included in a second appearance dictionary in accordance with a position of the human body represented on the partial image, and determines, on the basis of a result obtained by making reference to the specific appearance dictionary based on the appearance feature, whether or not the human body has fallen.

### (Supplementary Note 5)

The fall detection device according to any one of the supplementary notes 1 to 3, wherein

the appearance detection unit selects a specific appearance dictionary from one or more appearance dictionaries included in a third appearance dictionary in accordance with installation condition for a camera which has photographed the human body image, and determines, on the basis of a result obtained by making reference to the specific appearance dictionary based on the appearance feature, whether or not the human body is in fallen state.

### (Supplementary Note 6)

The fall detection device according to any one of the supplementary notes 1 to 3, wherein

the first appearance dictionary is a dictionary generated through learning by using the statistical pattern recognition technique on the basis of a human body image indicating the assumed state where the human body has fallen and where it does not fall.

### (Supplementary Note 7)

The fall detection device according to the supplementary note 4, wherein

the second appearance dictionary is a dictionary generated through learning by using the statistical pattern recognition technique on the basis of a human body image indicating the states where the human body has fallen and where it does not fall, which states are assumed for respective plural area divided with respect to respective appearances of the human body image.

### (Supplementary Note 8)

The fall detection device according to the supplementary note 5, wherein

the third appearance dictionary is a dictionary generated through learning by using the statistical pattern recognition technique on the basis of a human body image indicating the assumed states where the human body has fallen and where it does not fall, wherein the states are assumed for respective installation conditions for the camera.

### (Supplementary Note 9)

The fall detection device according to any one of the supplementary notes 1 to 3, wherein

the moving distance detection unit detects, when the moving distance is small continuously over a predetermined time, that the moving distance is small.

### (Supplementary Note 10)

The fall detection device according to the supplementary note 1 or 2, wherein

the position coordinate information is used position information indicating a position of the partial image of a plane coordinate system in the human body image.

### (Supplementary Note 11)

The fall detection device according to the supplementary note 1 or 2, wherein

the height information included in the size information is used the number of pixels in a height direction of the partial image in the human body image.

### (Supplementary Note 12)

The fall detection device according to the supplementary note 1 or 2, wherein

the height information included in the size information is used three-dimensional space information calculable on the basis of parameters of the camera that photographs the human body image calculated in advance.

### (Supplementary Note 13)

A fall detection method including:

detecting whether or not a height of a human body to be detected decreases, by comparing, on the basis of a human body image including a partial image indicating a human body, position coordinate information indicating a position on coordinate of the partial image and size information indicating the size of the human body indicated on the partial image, height information included in the size information and height information included in size information acquired in the past;

extracting an appearance feature on the basis of appearance of the human body image when the height decreases;

determining, on the basis of a result obtained by making reference to a first appearance dictionary on the basis of the appearance feature, whether or not the human body has fallen; and

calculating a moving distance of the partial image included in the human body image on the basis of the position coordinate information and position coordinate information acquired in the past when it is determined that there results fallen state, compare the moving distance and a threshold value, to detect, on the basis of the compared result, whether or not the moving distance of the partial image indicating the human body is smaller than the threshold value, when the moving distance is small, and detects that the human body included in the human body image has fallen.

### (Supplementary Note 14)

The fall detection method according to the supplementary note 13, further including:

determining whether or not the human body included in the human body image has fallen by performing a determination on the basis of a result obtained by detecting whether or not the height decreases, a result obtained by determining whether or not there results fallen state, and a result obtained by detecting whether or not the moving distance is small.

### (Supplementary Note 15)

A fall detection camera including:

a height detection unit that detects whether or not a height of a human body to be detected decreases, by comparing, on the basis of a human body including a partial image indicating the human body, position coordinate information indicating a position on coordinate of the partial image and size information indicating the size of the human body indicated on the partial image, height information included in the size information and height information included in size information acquired in the past;

an appearance feature extraction unit that extracts, when the height decreases, an appearance feature on the basis of appearance of the human body image;

an appearance detection unit that determines, on the basis of a result obtained by making reference to a first appearance dictionary on the basis of the appearance feature, whether or not the human body has fallen; and

a moving distance detection unit that calculates, when it is determined that there results fallen state, a moving distance of the partial image included in the human body image on the basis of the position coordinate information and position coordinate information acquired in the past, compares the moving distance and a threshold value, to detect, on the basis of the compared result, whether or not the moving distance of the partial image indicating the human body is smaller than the threshold value, when the moving distance is small, and detects that the human body included in the human body image has fallen.

### (Supplementary Note 16)

A computer program that controls an operation of a fall detection device, causing a computer to realize:

a function to detects whether or not a height of a human body to be detected decreases, by comparing, on the basis of a human body image including a partial image indicating the human body, position coordinate information indicating a position on coordinate of the partial image and size information indicating the size of the human body indicated on the partial image, height information included in the size information and height information included in size information acquired in the past;

a function to extract an appearance feature on the basis of appearance of the human body image when the height decreases;

a function to determine, on the basis of a result obtained by making reference to a first appearance dictionary on the basis of the appearance feature, whether or not the human body has fallen; and

a function to calculate a moving distance of the partial image included in the human body image on the basis of the position coordinate information and position coordinate information acquired in the past when it is determined that there results fallen state, to compare the moving distance and a threshold value, to detect, on the basis of the compared result, whether or not the moving distance of the partial image indicating the human body is smaller than the threshold value, when the moving distance is small, and detects that the human body included in the human body image has fallen.

This application claims for the priority based on the Japanese Patent Application No. 2012-157100, filed on Jul. 13, 2012, and is incorporated herein in the entirety of the disclosure.

### REFERENCE SIGNS LIST

1 Fall detection device
1a Fall detection device
2 Height detection unit
3 Appearance feature extraction unit
4 Moving distance detection unit
5 Appearance detection unit
6 Storage unit
7 Appearance dictionary
21 Determination unit
31 Appearance dictionary
32 First area information
33 Second area information
34 Third area information
35 Fourth area information
36 Fifth area information
37 Sixth area information
41 Appearance dictionary
42 First camera information
43 Second camera information
44 Third camera information
101 Input data
300 Information processing apparatus
301 CPU
302 ROM
303 RAM
304 Hard disk
305 Communication interface
306 Bus
307 Storage medium
308 Reader/Writer

What is claimed is:

1. A fall detection device comprising:
a height detection unit that detects whether or not a height of a human body to be detected decreases, by comparing, on the basis of a human body image including a partial image indicating the human body, position coordinate information indicating a position on coordinate of the partial image and size information indicating the size of the human body indicated on the partial image, height information included in the size information and height information included in size information acquired in the past;
an appearance feature extraction unit that extracts, when the height decreases, an appearance feature on the basis of appearance of the human body image;
an appearance detection unit that determines, on the basis of a result obtained by making reference to a first appearance dictionary on the basis of the appearance feature, whether or not the human body has fallen; and
a moving distance detection unit that calculates, when it is determined that there results fallen state, a moving distance of the partial image included in the human body image on the basis of the position coordinate information and position coordinate information acquired in the past, compares the moving distance and a threshold value, to detect, on the basis of the compared result, whether or not the moving distance of the partial image indicating the human body is smaller than the threshold value, when the moving distance is small, and detects that the human body included in the human body image has fallen.

2. The fall detection device according to claim 1, further comprising:
a determination unit that detects whether or not the human body included in the human body image has fallen by performing a determination on the basis of a determination result at the appearance detection unit and a detection result at the moving distance detection unit.

3. The fall detection device according to claim 2, wherein
the determination unit detects that the human body has fallen, when it acquires from the height detection unit, a detection result that the height of the human body decreases, acquires from the appearance detection unit, a determination result that the human body has fallen state, and acquires from the moving distance detection unit, a detection result that the moving distance of the partial image indicating the human body is small.

4. The fall detection device according to claim 1, wherein
the appearance detection unit selects a specific appearance dictionary from one or more appearance dictionaries included in a second appearance dictionary in accordance with a position of the human body represented on the partial image, and determines, on the basis of a result obtained by making reference to the specific appearance dictionary based on the appearance feature, whether or not the human body has fallen.

5. The fall detection device according to claim 1, wherein
the appearance detection unit selects a specific appearance dictionary from one or more appearance dictionaries included in a third appearance dictionary in accordance with installation condition for a camera which has photographed the human body image, and determines, on the basis of a result obtained by making reference to the specific appearance dictionary based on the appearance feature, whether or not the human body is in fallen state.

6. The fall detection device according to claim 1, wherein
the first appearance dictionary is a dictionary generated through learning by using the statistical pattern recognition technique on the basis of a human body image indicating the assumed state where the human body has fallen and where it does not fall.

7. A fall detection method comprising:
detecting whether or not a height of a human body to be detected decreases, by comparing, on the basis of a human body image including a partial image indicating the human body, position coordinate information indicating a position on coordinate of the partial image and size information indicating the size of the human body indicated on the partial image, height information included in the size information and height information included in the size information acquired in the past;
extracting an appearance feature on the basis of appearance of the human body image when the height decreases;
determining, on the basis of a result obtained by making reference to a first appearance dictionary on the basis of the appearance feature, whether or not the human body has fallen; and
calculating a moving distance of the partial image included in the human body image on the basis of the position coordinate information and position coordinate information acquired in the past when it is determined that there results fallen state, compare the moving distance and a threshold value, to detect, on the basis of the compared result, whether or not the moving distance of the partial image indicating the human body is smaller than the threshold value, when the moving distance is small, and detects that the human body included in the human body image has fallen.

8. The fall detection method according to claim 7, further including:
determining whether or not the human body included in the human body image has fallen by performing a determination on the basis of a result obtained by detecting whether or not the height decreases, a result obtained by determining whether or not there results fallen state, and a result obtained by detecting whether or not the moving distance is small.

9. A fall detection camera comprising:
a height detection unit that detects whether or not a height of a human body to be detected decreases, by comparing, on the basis of a human body including a partial image indicating the human body, position coordinate information indicating a position on coordinate of the partial image and size information indicating the size of the human body indicated on the partial image, height information included in the size information and height information included in size information acquired in the past;
an appearance feature extraction unit that extracts, when the height decreases, an appearance feature on the basis of appearance of the human body image;
an appearance detection unit that determines, on the basis of a result obtained by making reference to a first appearance dictionary on the basis of the appearance feature, whether or not the human body has fallen; and
a moving distance detection unit that calculates, when it is determined that there results fallen state, a moving distance of the partial image included in the human body image on the basis of the position coordinate information and position coordinate information acquired in the past, compares the moving distance and a threshold value, to detect, on the basis of the compared result, whether or not the moving distance of the partial image indicating the human body is smaller than the threshold value, when the moving distance is small, and detects that the human body included in the human body image has fallen.

10. A non-transitory computer readable media storing, a computer program that controls an operation of a fall detection device, causing a computer to realize:
a function to detects whether or not a height of a human body to be detected decreases, by comparing, on the basis of a human body image including a partial image indicating the human body, position coordinate information indicating a position on coordinate of the partial image and size information indicating the size of the human body indicated on the partial image, height information included in the size information and height information included in size information acquired in the past;
a function to extract an appearance feature on the basis of appearance of the human body image when the height decreases;
a function to determine, on the basis of a result obtained by making reference to a first appearance dictionary on the basis of the appearance feature, whether or not the human body has fallen; and
a function to calculate a moving distance of the partial image included in the human body image on the basis of the position coordinate information and position coordinate information acquired in the past when it is determined that there results fallen state, to compare the moving distance and a threshold value, to detect, on the basis of the compared result, whether or not the moving distance of the partial image indicating the human body is smaller than the threshold value, when the moving distance is small, and detects that the human body included in the human body image has fallen.

11. The fall detection device according to claim 4, wherein
the second appearance dictionary is a dictionary generated through learning by using the statistical pattern recognition technique on the basis of a human body image indicating the states where the human body has fallen and where it does not fall, which states are assumed for respective plural area divided with respect to respective appearances of the human body image.

12. The fall detection device according to claim 5, wherein
the third appearance dictionary is a dictionary generated through learning by using the statistical pattern recognition technique on the basis of a human body image indicating the assumed states where the human body has fallen and where it does not fall, wherein the states are assumed for respective installation conditions for the camera.

13. The fall detection device according to claim 1, wherein
the moving distance detection unit detects, when the moving distance is small continuously over a predetermined time, that the moving distance is small.

14. The fall detection device according to claim 1, wherein
the position coordinate information is used position information indicating a position of the partial image of a plane coordinate system in the human body image.

15. The fall detection device according to claim 1, wherein
the height information included in the size information is used the number of pixels in a height direction of the partial image in the human body image.

16. The fall detection device according to claim 1, wherein
the height information included in the size information is used three-dimensional space information calculable on the basis of parameters of the camera that photographs the human body image calculated in advance.
